(19) United States
(12) Patent Application Publication
(10) Pub. No.: US 2021/0022327 A1
(43) Pub. Date: Jan. 28, 2021

(54) TELESCOPING POLE SPEAR

(71) Applicant: Michael Barber, (US)

(72) Inventors: Michael Barber, Encinitas, CA (US); Ian Kovacevich, Carlsbad, CA (US); Kassie Betts, Carlsbad, CA (US); Paul Seiter, San Diego, CA (US)

(73) Assignee: Michael Barber, Encinitas, CA (US)

(21) Appl. No.: 16/931,195

(22) Filed: Jul. 16, 2020

Related U.S. Application Data
(60) Provisional application No. 62/875,325, filed on Jul. 17, 2019.

(51) Int. Cl. A01K 81/04; B25G 1/04

(52) U.S. Cl. CPC A01K 81/04; B25G 1/04

(57) ABSTRACT

A collapsible and extendable rod comprising a plurality of rod sections. Each section coupled together at any an intersection of two said rod sections with an intersection assembly. Any two adjacent rod sections may be configured such that at least one of the two rod section of the two adjacent rod sections may nest internal to the other adjacent rod sections thereby forming a collapsed configuration. The collapsed configuration may include any number of rod sections provided there is at least a first largest rod section and at least a last smallest rod section. The last smallest rod section may be the most internal rod of the nested configuration and the first largest rod section may be the most external of the nested configuration. The collapsed configuration may be fully reversible to an extended configuration.

### RELATED APPLICATIONS

This application claims the benefit of U.S. Provisional Application No. 62/875,325 filed Jul. 17, 2019, the contents of which are incorporated by this reference in their entireties for all purposes as if fully set forth herein.

### TECHNICAL FIELD

The disclosure herein relates generally to devices and methods for fishing. More particularly, the disclosure relates to devices and methods to facilitate the hunting, spearing, and collection of wild aquatic species, in both ocean and lake settings, complete with compact holster for easy transportation. Said species may be generally classified as vertebrates or invertebrates.

### BACKGROUND

The use of spear systems for fishing and hunting are known. Several different types of devices exist to launch a spear underwater. Generally, these types are broken into three groups: spearguns, pole spears, and Hawaiian slings. Spear systems previously devised and utilized are known to consist basically of familiar, expected, and obvious structural configurations dependent on the group.

A pole spear generally includes a shaft with a sharpened tip on one end and a rubber sling on the other. With one hand, a user grips the spear shaft and the rubber sling. With the second hand, a user grips the pole and pulls the sling toward the spear tip providing tension forces and potential energy built up into the rubber sling. The user may hold the spear and the rubber sling in one hand, pointing the spear tip towards an intended target, fish, or other game meant for sport or consumption. Upon releasing the pole, while still holding the rubber sling, the potential energy is converted into kinetic energy and the pole is propelled, speartip forward, towards the intended target.

Using a pole spear in this intended manner allows an individual or hunter to strike a target or game animal from a relative distance. The pole is of a length sufficient to extend well beyond the user of the pole spear. Because of the advantage of distance in the striking range, a user can use stealth and surprise over an intended target and strike when most advantageous to the user. Moreover, because a pole spear is very simple to use, the failure rate of any given pole spear is low. Failure to catch game depends more on the ability of the individual to properly aim the tip and less on the failure of the pole spear itself.

Because the pole spear was designed with hunting fish and game in mind, the numerous benefits conferred to a user exist while deployed in the filed only. When the pole spear is not being used in a hunting scenario, there exist drawbacks as it relates to the basic design of a pole spear, especially as it relates to storing and transporting the pole spear. Specifically, the length of the pole spear makes storing the spear difficult, either requiring the removal of the spear tip for upside-down vertical storage, storage on a horizontal axis, or leaving the spear tip on and storing vertically on the rubber sling. Each of these options is less than ideal. Removal of the spear tip risks losing a misplaced spear tip. Storage on a horizontal axis requires considerable space. Storage on the rubber sling could result in premature degradation of the sling, which is vital to the function of the pole spear.

Therefore, it can be appreciated that there exists a need for a pole spear assembly which is easily and safely stored and transported. This new and improved pole spear assembly should take up minimal space, not be bound by the awkward nature of a lengthy pole, can be transported to the hunting site with minimal effort, and can be easily and rapidly prepared for use in the field once on site.

### SUMMARY

Certain deficiencies of the prior art are overcome by the provision of embodiments of an apparatus, kit and system in accordance with the present disclosure. Herein described may be a collapsible and extendable rod comprising a plurality of rod sections, each of the rod sections may be coupled together at any an intersection of two said rod sections with an intersection assembly. Any two adjacent rod sections may be configured such that at least one of the two rod section of the two adjacent rod sections may nest internal to the other adjacent rod sections thereby forming a collapsed configuration. The collapsed configuration may include any number of rod sections provided there is at least a first largest rod section and at least a last smallest rod section. The last smallest rod section may be the most internal rod of the nested configuration and the first largest rod section may be the most external of the nested configuration. The collapsed configuration may be fully reversible to an extended configuration. Further, the intersection assembly may comprise a plunge element having a disengagement groove disposed circumferentially about the plunge element, a coupling element which may have a multiplicity of a coupling detent slots and may be configured to couple any uncoupled rod sections together, a retention element which may have a multiplicity of a retention detent slots, a multiplicity of detent elements which may be configured to move between the disengagement groove and both coupling detent slots and the retention detent slots.

The said movement of the detent elements from the coupling detent slots and the retention detent slots to the disengagement groove may result in the collapsed configuration of the last rod section into any of the adjacent rod section until fully collapsed into the first rod section. Further, the movement of the detent elements from the disengagement groove to the coupling detent slots and the retention detent slots may result in a maintenance of the extended configuration of the any of the adjacent rod section out from the first rod section until fully extended to the last rod section. A biasing element may be configured to reversibly retain the detent elements in the coupling detent slots and the retention detent slots when the spear is in an extended configuration. The intersection assembly may further comprise an abutment element.

The collapsibility of the pole spear may be initiated by a depression of the release button. This action may therein cause the push rod to push the plunge element of the third intersection assembly and against the biasing element of the third intersection assembly. Said action may thereby cause the detent elements to move from both the coupling detent slots and the retention detent slots into the disengagement groove which thereby may allow the rear portion to reversibly collapse into the second middle portion. Each subsequent section may therein automatically collapse into the next section as described in this disclosure.

The band loop may be configured to hold an elastic band, said elastic band may be made of rubber. The first largest rod section may be further configured to threadably receive a tip insert, the tip insert may be configured to reversibly threadably receive a tip.

### BRIEF DESCRIPTION OF THE DRAWINGS

Further advantages of the present disclosure may become apparent to those skilled in the art with the benefit of the following detailed description of the preferred embodiments and upon reference to the accompanying drawings in which:

FIG. 1 is a perspective view of an apparatus (devices) in accordance with one non-limiting embodiment of a telescoping pole spear to facilitate the striking of targets, hunting, and fishing with the pole spear assembly in an extended configuration;

FIG. 2 is an enlarged perspective view of one non-limiting embodiment of a spear tip end of the pole spear assembly for hunting, fishing, and target striking, wherein the apparatus is shown with a spear tip in a three prong configuration;

FIG. 3 is an exploded view of one non-limiting embodiment of the telescoping pole spear assembly;

FIG. 4 is an orthogonal view of one non-limiting embodiment of the telescoping pole spear assembly;

FIG. 5 is an enlarged perspective view of one non-limiting embodiment of a rear end of the pole spear assembly for hunting, fishing, and target striking;

FIG. 6 is an enlarged cross-sectional view of one non-limiting embodiment of the telescoping pole spear in an extended and locked configuration wherein detent elements are seated into a sidewall groove of a side wall;

FIG. 7 is an enlarged cross-sectional view of one non-limiting embodiment of the telescoping pole spear in a collapsing and unlocked configuration wherein detent elements are disengaged from a sidewall groove and collapse of the spear is initiated;

FIG. 8 is an enlarged cross-sectional view of one non-limiting embodiment of the telescoping pole spear in a collapsing and unlocked configuration wherein the adjacent detent elements are seated into a sidewall groove and collapse of the spear is progressing sectionally;

FIG. 9 is an enlarged cross-sectional view of one non-limiting embodiment of the telescoping pole spear in a collapsing and unlocked configuration wherein collapsing is preceding sectionally;

FIG. 10 is an enlarged cross-sectional view of one non-limiting embodiment of the telescoping pole spear in a collapsing and unlocked configuration wherein collapsing is preceding sectionally;

FIG. 11 is an enlarged cross-sectional view of one non-limiting embodiment of the telescoping pole spear in a collapsing and unlocked configuration wherein collapsing is preceding sectionally;

FIG. 12 is an enlarged cross-sectional view of one non-limiting embodiment of the telescoping pole spear in a collapsing and unlocked configuration wherein collapsing is preceding sectionally;

FIG. 13 is an orthogonal view of one non-limiting embodiment of a telescoping pole spear in a fully collapsed configuration;

FIG. 14 is a cross-sectional side view of one non-limiting embodiment of a telescoping pole spear in a fully collapsed configuration;

FIG. 15 is a perspective view of one non-limiting embodiment of a telescoping pole spear in a fully extended configuration;

FIG. 16 is a plan view of one non-limiting embodiment of a telescoping pole spear in a fully extended configuration;

FIG. 17 is an exploded perspective view of one non-limiting embodiment of a telescoping pole spear wherein one or more than one intersection assemblies are illustrated in addition to other components;

FIG. 18 is an enlarged cross-sectional view of one non-limiting embodiment of the telescoping pole spear in an extended and locked configuration wherein detent elements are seated into a sidewall groove of a side wall;

FIG. 19 is an enlarged cross-sectional view of one non-limiting embodiment of the telescoping pole spear in a collapsing and unlocked configuration wherein detent elements are disengaged from a sidewall groove and collapse of the spear is initiated;

FIG. 20 is an enlarged cross-sectional view of one non-limiting embodiment of the telescoping pole spear in a collapsing and unlocked configuration wherein the adjacent detent elements are seated into a sidewall groove and collapse of the spear is progressing sectionally;

FIG. 21 is an enlarged cross-sectional view of one non-limiting embodiment of the telescoping pole spear in a collapsing and unlocked configuration wherein collapsing is preceding sectionally;

FIG. 22 is an enlarged cross-sectional view of one non-limiting embodiment of the telescoping pole spear in a collapsing and unlocked configuration wherein collapsing is preceding sectionally;

FIG. 23 is an enlarged cross-sectional view of one non-limiting embodiment of the telescoping pole spear in a collapsing and unlocked configuration wherein collapsing is preceding sectionally;

FIG. 24 is an enlarged cross-sectional view of one non-limiting embodiment of the telescoping pole spear in a collapsing and unlocked configuration wherein collapsing is preceding sectionally;

FIG. 25 is a plan view of one non-limiting embodiment of a telescoping pole spear in a fully collapsed configuration;

FIG. 26 is a cross-sectional side view of one non-limiting embodiment of a telescoping pole spear in a fully collapsed configuration; and,

FIG. 27 is an orthogonal view of one non-limiting embodiment of an intersection assembly.

### DETAILED DESCRIPTION OF THE PREFERRED EMBODIMENTS

Referring now to the drawings, like reference numerals designate identical or corresponding features throughout the several views. Further, described herein are certain non-limiting embodiments of a pole spear assembly 100.

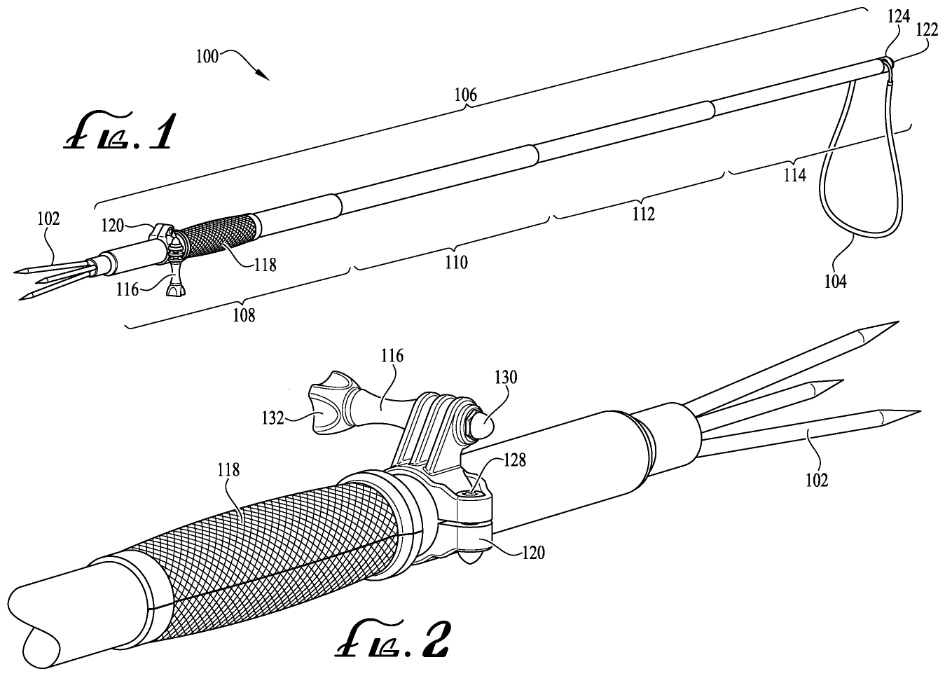

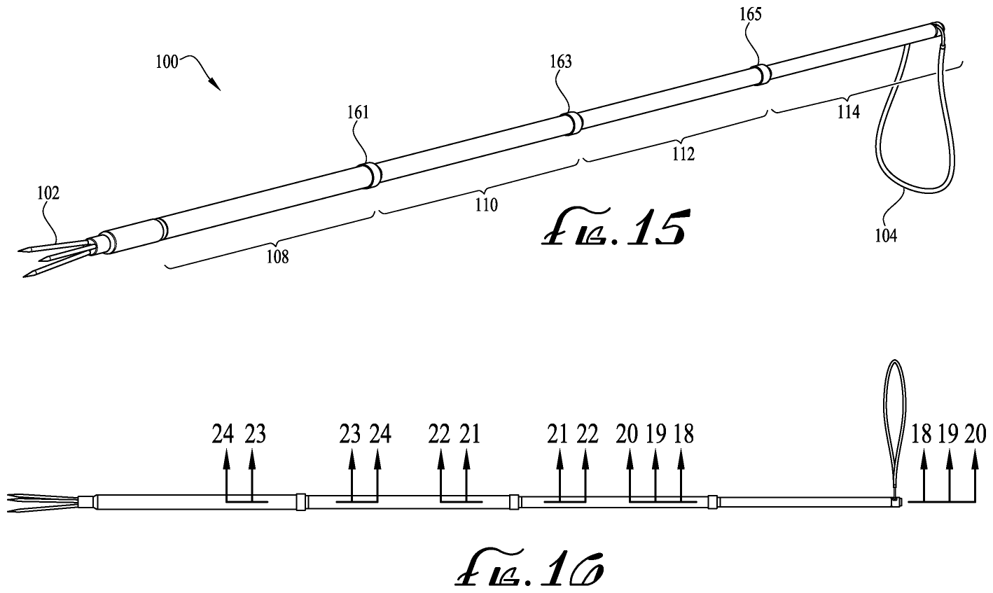

Shown in FIGS. 1 and 15 are pole spear assembly 100 in a fully extended and ready to use configuration. Relevant portions include a tip 102, a rubber sling 104, and a shaft assembly 106. The shaft assembly 106 may comprise a forward portion 108, a first middle portion 110, a second middle portion 112, and a rear portion 114. The forward portion 108 may further comprise a camera mount 116 and a grip 118 for gripping the shaft assembly 106. The grip 118 may be of any number of waterproof materials, for example, silicone, hard plastic, or corrosion other resistant metals. Further, the grip 118 may be aided by the application of a pattern applied to the exterior of the grip 118, the pattern may be that of a grid, a diamond, or other patterns which improve frictional contact between a user's hand and the shaft assembly. The camera mount 116 may be held to the shaft assembly 106 by way of a camera mount clip 120 which may be located in proximity to the grip 118. Further shown in FIG. 1 is the rear portion 114 which may comprise a release button 122 for collapsing the spear assembly 106 and a band loop 124 for holding the rubber sling 104. The release button 122 may be located proximate to the band loop 124. Further illustrated are the general locations of a first intersection assembly 161, a second intersection assembly 163, and a third intersection assembly 165.

Referring now to FIG. 2, shown is the forward most section of the forward portion 108 of the shaft assembly 106 with the tip 102. The tip 102 may be a three-prong tip as shown in FIGS. 1 and 2, or may be a single prong, double prong, or may comprise more than three prongs. The tip 102 may generally be the section of the pole spear assembly 100 which impales a fish or other game and may immobilize the fish or other game such that a fisherman or hunter my collect the catch. The grip 118 is shown in greater detail with a diamond pattern placed on to the surface of the grip 118. However, it should be appreciated that any number of patterns are contemplated, and the pattern may be formed to the exterior of the grip 118 by reduction methods known in the industry which may remove material by cutting or engraving, or by methods of embossing or debossing to achieve the different or similar pattern.

Further shown in FIG. 2 is the camera mount 116 in greater detail. A clip fastener 128 is shown providing a compressive force to the camera mount clip 120, which may circumferentially grip a section of the shaft assembly 106 further preventing movement of the camera mount 116. A fasting nut 130 is shown coupled to the camera mount 116, which may be further tightened by a hand fastening nut 132. The hand fastening nut 132 allows a user to adjust the camera mount 116 in situ with minimal effort.

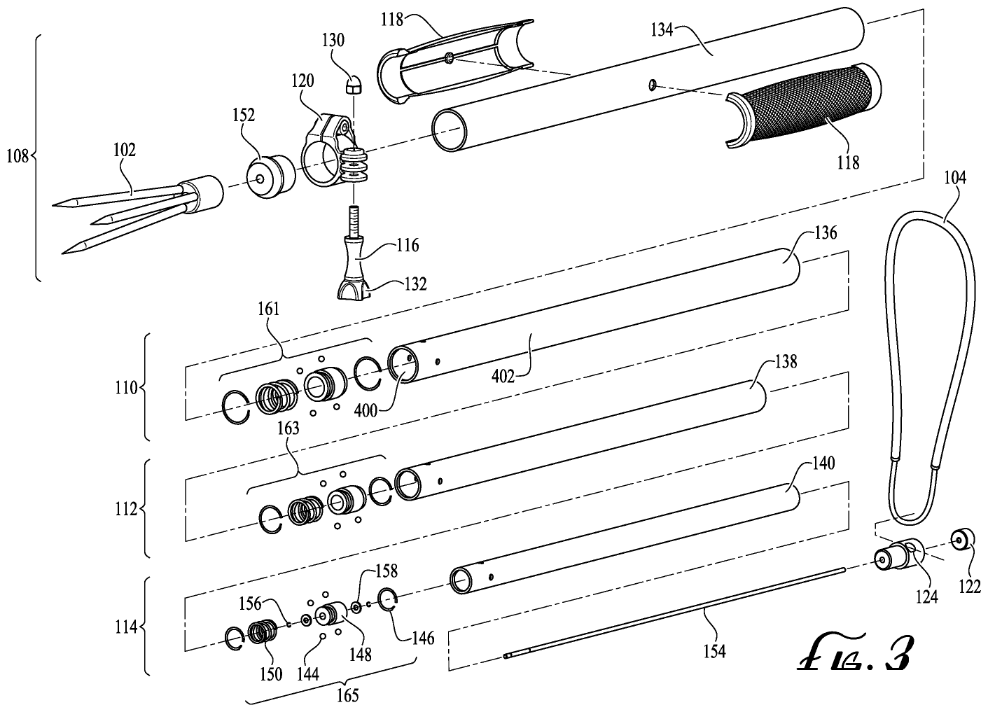

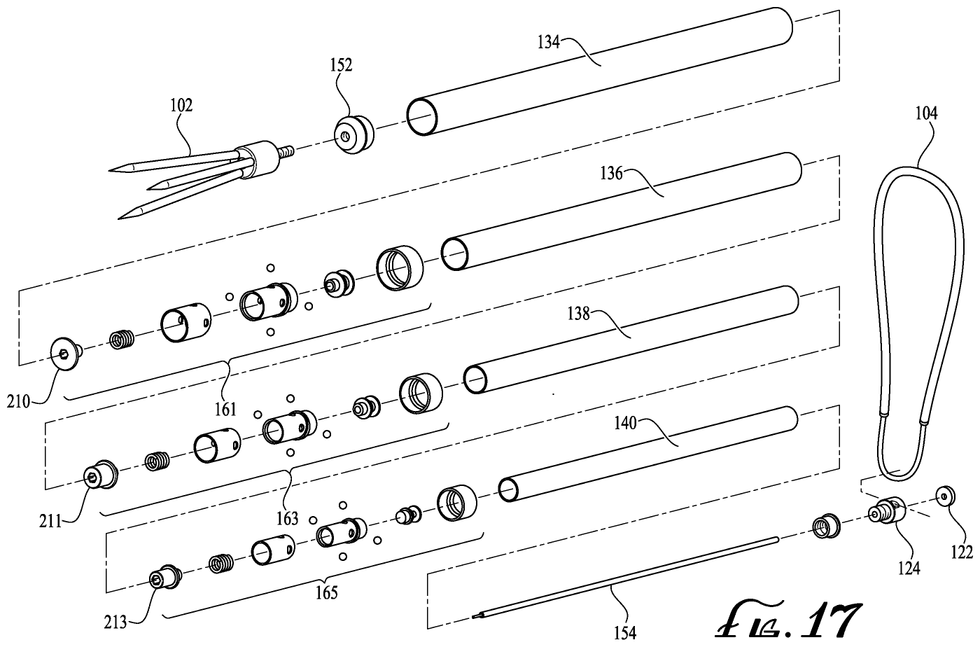

FIGS. 3 and 17 show a first pole member 134, a second pole member 136, a third pole member 138, and a fourth pole member 140 (the forth pole member may additionally be referred to as a last pole member 140, and collectively, each pole member may additionally be referred to as rod section; thus, the first pole member 134 may be referred to as a first rod section 134 and the last pole member 140 may additionally be referred to as a last rod section 140.) The diameter of the first pole member 134 may be the largest of each of the following pole members. The second pole member 136 may have a diameter smaller than the first pole member 134 such that the second pole member 136 may fit, or nest, internal to the first pole member 134. The third pole member 138 may have a diameter smaller than the second pole member 136 such that the third pole member 138 may fit, or nest, internal to the second pole member 136. The fourth pole member 140 may have a diameter smaller than the third pole member 138 such that the fourth pole member 140 may fit, or nest, internal to the third pole member 138.

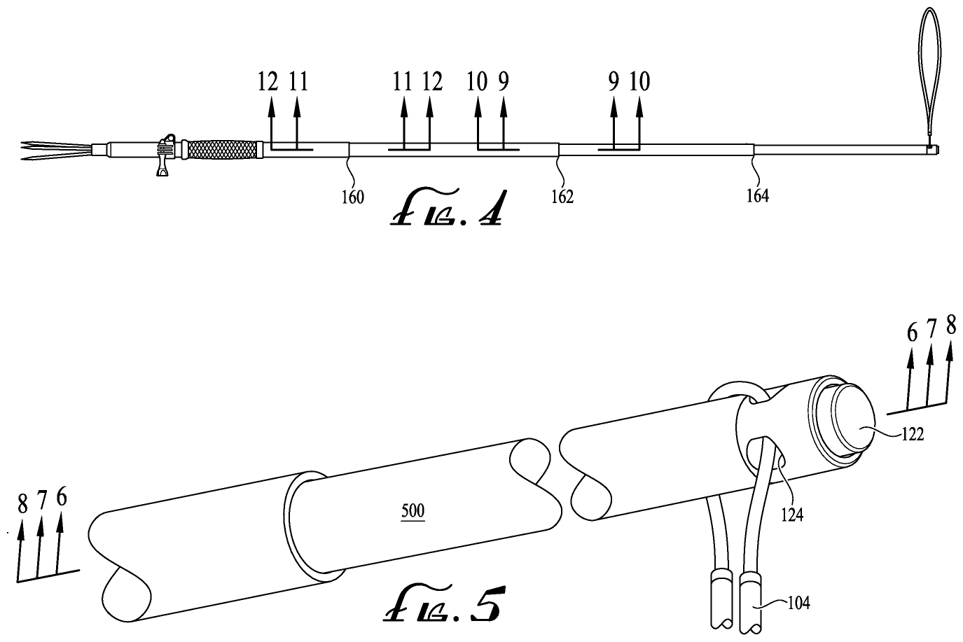

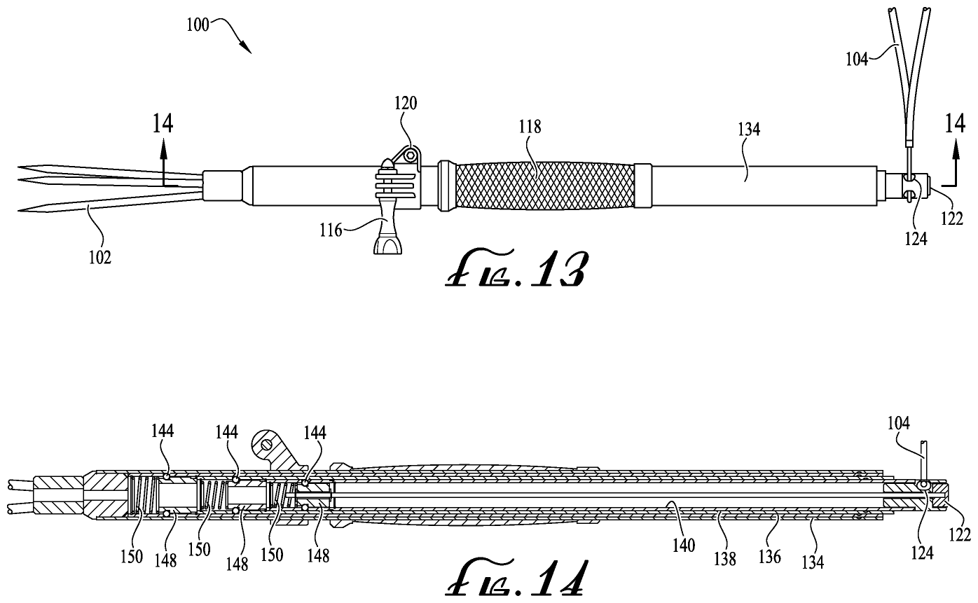

Collectively, any single pole member may be referred to as a rod section 500 (as shown in FIG. 5) as the only difference between any two pole members 500 is the diameter, thus they should be collectively conceptualized, and referred to generally as rod section 500. There may be any number of rod sections 500, provided that there is at least a first rod section 134 which is largest in diameter and a last rod section 140 which is smallest in diameter. Additionally, each rod section 500 may have an internal side 400 and an external side 402. When fully collapsed, the fourth pole member 140 may sit internal to the third pole member 138 and the third pole member 138 may sit internal to the second pole member 136 and the second pole member 136 may sit internal to the first pole member 134 and the first pole member 134 may be the outermost exposed portion of the shaft assembly 106 as illustrated in FIGS. 13, 14, 25, and 26.

Further shown in FIGS. 3 and 17 are a multiplicity of intersection assemblies 142 (may also be referred to as internal components 142) of the shaft assembly 106. Said intersection assemblies 142 (as also shown in FIG. 27) may be repeated at each point between two pole members. Each of the forward portion 108, first middle portion 110, second middle portion 112, and rear portion 114 may contain the similar intersection assembly 142 for the operation of the extension and collapse features of the pole spear assembly 100. The intersection assembly 142 may comprise a plurality of detent element 144, a plurality of retaining clip 146, a plurality of plunger element 148, and a plurality of biasing element 150. The retaining clip 146 may be of any type suitable for retention and known in the industry. The retaining clip 146 retains the detent element 144, the plunger element 148, and the biasing element 150 (collectively referred to as intersection assembly 142) in place and therefore at least one or more retaining clip 146 may be placed before and after intersection assembly 142. The retaining clip 146 may be any number of clips commonly used in the industry to maintain slidable and/or rigid communication with other assembly parts, for example, biasing element clips, wrist pin locks, retaining rings, E type circle clips, internally mounted axial ring or radial retaining rings.

While it is understood that those in the art will understand the scope and function of the intersection assemblies 142 (as illustrated in FIG. 27) and should therefore not require further specificity, for the ease of understanding this disclosure only, further illustrated in FIGS. 3 and 17 are intersection assemblies 142 as potentially including a first intersection assembly 161, a second intersection assembly 163, and a third intersection assembly 165. The number of intersection assemblies 142 is dependent on the number of rod sections 500 (pole members 500) elected to be included in the pole spear assembly 100. The components of the assemblies are generally similar to a degree in which they may be interchangeable. Additionally illustrated are a series of abutment elements 210, 211, and 213. While generally considered interchangeable, some differences may exist, accordingly, a first abutment element 210, a second abutment element 211, and a third abutment element 213 are additionally disclosed.

For each of the forward portion 108, first middle portion 110, second middle portion 112, and rear portion 114, the intersection assembly 142 may be sized to appropriately fit in the corresponding diameter of the respective first pole member 134, the respective second pole member 136, the respective third pole member 138, and the respective fourth pole member 140. For each of the first pole member 134, the second pole member 136, the third pole member 138, and the fourth pole member 140 the intersection assembly 142 are placed in the foremost position as indicated in the various FIGS.

Still referring to FIG. 3, shown this embodiment may be a tip insert 152 for holding and mounting the tip 102. The tip insert 152 may couple with a tri-pointed tip 102 as shown, or a single tip 102, a double tip 102, or a tip 102 with any number of points commonly used for sport or game fishing. The tip insert 152 may be configured such that a male or female connection end of the tip 102 may appropriately couple with the tip insert 152. The grip 118 is illustrated as halved, such that two equal portions of the grip 118 may be laterally mounted to the first pole member 134. The grip 118 and the tip insert 152 may be coupled to the pole spear assembly 100 by fasteners commonly used in the industry, for example, screws, pegs, bolts, clips, or rivets.

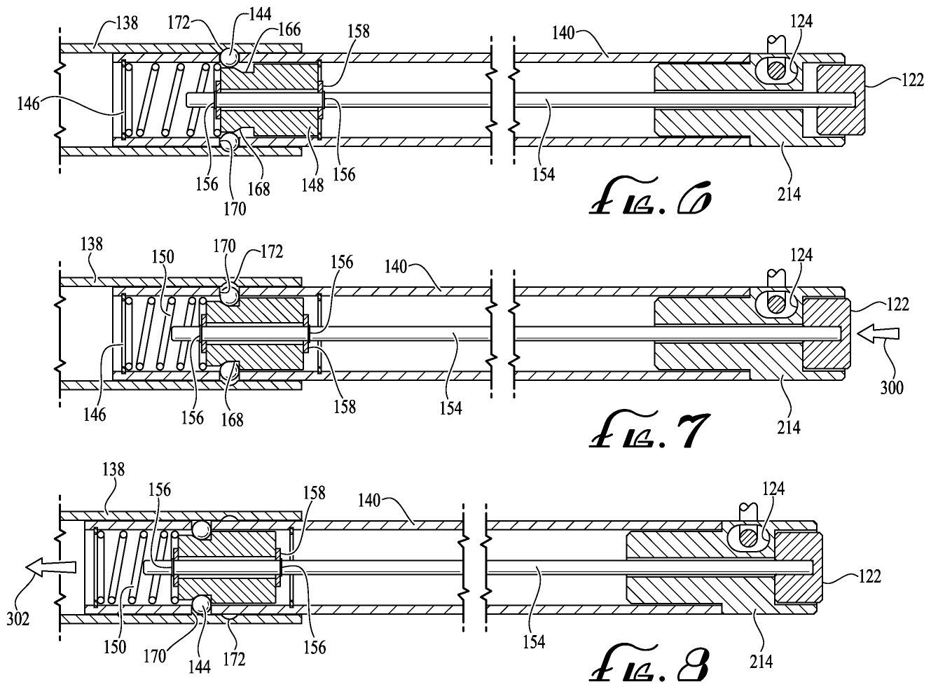

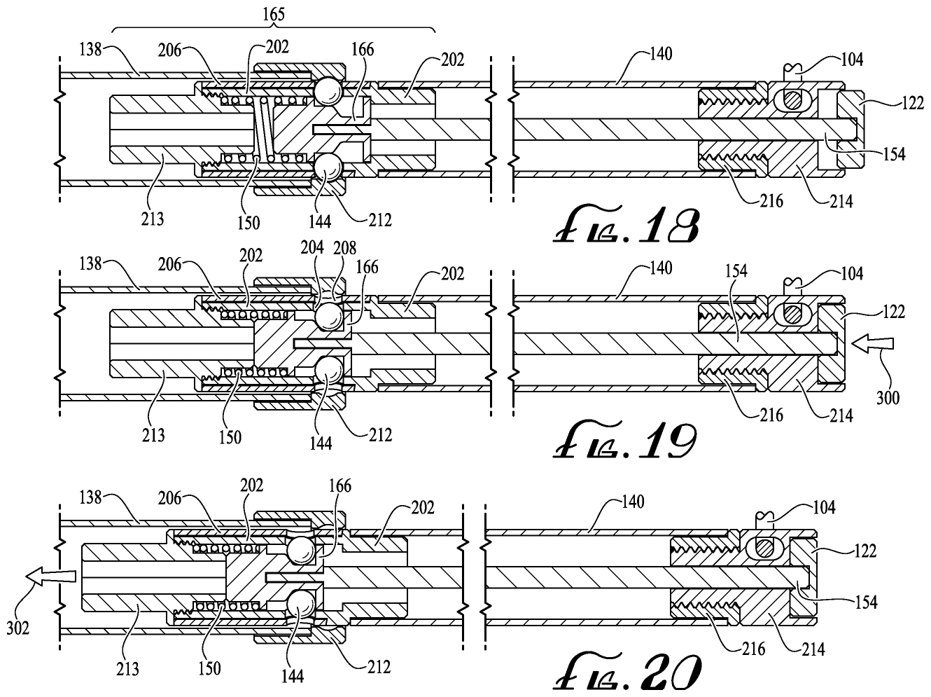

FIG. 3 further illustrates the release button 122. Associated with the release button 122 is a push rod 154 which may act to initiate the collapse of the shaft assembly and further illustrated in FIGS. 7 and 19. A plunger retaining clip 156 is shown and may be located to the fore and aft of plunger element 148 in rear portion 114. The plunger retaining clip 156 may be used in rear portion 114 to maintain communication between the push rod 154 and the plunger element 148. Further used to the fore and aft of the plunger may be an annular stop 158 which may further enhance communication between the plunger element 148 and the plunger retaining clip 156, such that no slide may occur of plunger element 148 on push rod 154.

Referring now to FIGS. 4 and 5, shown may be a first intersection 160, a second intersection 162, and a third intersection 164. The collapse of the pole spear assembly 100 may occur by first depressing the release button 122 on the rear portion 122. As the collapse progresses, the first intersection 160 may collapse, followed by the second intersection 162, followed finally by the third intersection 164, at which point the pole spear assembly 100 may be compacted to the shortest configuration. Said collapse may be automatic and not requiring further user input beyond the initial depression of release button 122.

Referring now to FIG. 5, shown is rear portion 114. Band loop 124 is illustrated in greater detail and as illustrated is to one lateral side of rear portion 114. It is contemplated that band loop 124 may be placed to any other lateral side, or to the center. Further, while the band loop 124 is illustrated as being an aperture to the rear portion 114, it is contemplated that the method of connecting the rubber sling 104 to the rear portion 114 may occur by a multitude of options. For example, band loop 124 is contemplated to be a hook type shape, an extruded and attached annular shape, or of any geometric shape which will not cause unnecessary strain to rubber sling 104 and may be further located to any lateral location of the rear portion 114 provided that the collapse function of the pole spear assembly 100 is not hindered. The release button 122 may be held in place by an end retention element 214 (as illustrated in FIGS. 6 and 18).

Referring now to FIGS. 6 and 18, shown may be a partial operation of the intersection assembly 142 (as illustrated in FIGS. 3 and 27) of rear portion 114. Plunger element 148 may have a plurality of engagement groove 166. The engagement groove 166 may be designed to engage and disengage with detent element 144. Shown in FIG. 6 is the plunger element 148 and detent element 144 in a fully telescoped configuration of the pole spear assembly 100. The plunger element 148 may have engagement ramp 168 which, in combination with the biasing element 150, may bias the detent element 144 through a detent slot 170 (also may be referred to as a sidewall slot 170) when the plunger element 148 is pulled to the rear end of the shaft assembly 106. The engagement ramp 168 may be angled such that the biasing occurs as a result of an external tension force applied to the rear portion 114 by the user as the user extends the pole spear assembly 100 to an extended configuration and may be maintained in a biased configuration from biasing element 150.

Still referring to FIGS. 6 and 18, the detent slot 170 may be generally configured in an annular shape and may be designed to engage with a spherical object, such as a detent element 144; however, other shapes are contemplated, including a variety of geodesic configurations. As noted, the engagement ramp 148 and biasing element 150 may bias the detent element 144 through the detent slot 170 and into a sidewall groove 172. The sidewall groove 172 may be configured to accept detent element 144. The acceptance of detent element 144, through the detent slot 170 and into the sidewall groove 172 from biasing element 150 and engagement ramp 168 results in a locking in the extended configuration of the pole spear assembly 100 and may be ready for in situ use. The biasing element 150 provides a resilient bias against plunger element 148 such that the engagement ramp 168 cannot be accessed by the detent element 144 while in an extended configuration. Additional embodiments may include a coupling element 202. The coupling element 202 may include coupling detent slots 204 (shown in FIG. 19) which may align with the sidewall groves 172 and detent slots 170. Additionally, some embodiments may include an annular collar 212 and retention element 206 to further aid in the mechanical movement of detent elements 144 and the pole spear assembly 100 more generally. The retention element may further include retention detent slots 208. An (third) abutment element 213 is additionally shown and it should be clarified that the term “abutment element” may be used to refer to the first abutment element 210, the second abutment element 211, and the third abutment element 213.

Turning to FIGS. 7 and 19, shown may be the initial action 300 for the initial collapsing process of the pole spear assembly 100. To collapse, the user of the device depresses the release button 122. The depression of release button 122 may result in the depression of push rod 154 due to the release button 122 being located aft of the push rod 154. The push rod 154 then compressively communicates with the plunger element 148 and against the resilient bias provided by biasing element 150. The push rod 154 may be able to compressively communicate with the plunger element 148 due to the plunger retaining clip 156 and annular stop 158. The plunger retaining clip 156 and annular stop 158 may be in plurality, may be placed both before and after plunger element 148, and located on push rod 154 such that any sliding motion of the push rod 154 may be translated to the plunger element 148. Plunger retaining clip 156 and annular stop 158 may be any number of clips and/or washers commonly used in the industry to maintain slidable and/or compressive communication with other assembly parts, for example, biasing element clips, wrist pin locks, retaining rings, E type circle clips, internally mounted axial ring, or radial retaining rings.

Still referring to FIGS. 7 and 19, said depression of push rod 154 will depress plunger element 148 against biasing element 150 such that plunger element 148 may be slidably moved towards the next section (the second middle portion 112 shown in FIG. 3) against the bias of biasing element 150. The described movement may cause the engagement ramp 168 to become accessible to the detent element 144, and allow the detent element 144 to insert to the engagement groove 166 and detent slot 170. With the detent element 144 located in the engagement groove 166 and detent slot 170, the detent element 144 may no longer occupy the sidewall groove 172 thereby permitting the fourth pole member 140 to slide into the third pole member 138 (as shown in FIG. 8). Additional embodiments may include a coupling element 202. The coupling element 202 may include coupling detent slots 204 (shown in FIG. 19) which may align with the sidewall groves 172 and detent slots 170. Additionally, some embodiments may include an annular collar 212 and retention element 206 to further aid in the mechanical movement of detent elements 144 and the pole spear assembly 100 more generally. The retention element may further include retention detent slots 208. An (third) abutment element 213 is additionally shown and it should be clarified that the term “abutment element” may be used to refer to the first abutment element 210, the second abutment element 211, and the third abutment element 213.

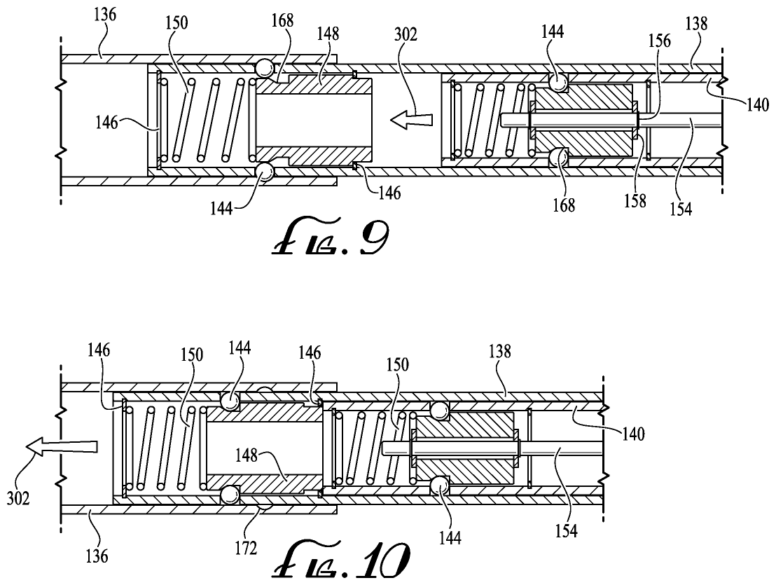

Shown in FIGS. 8 and 20 may be the forward movement 302 of the indicated section. Specific to this figure, movement 302 illustrates the movement of the rear portion 114 in a direction toward the second middle portion 112 (as illustrated in FIG. 9). The detent element 144 is now no longer engaged with sidewall groove 172 and may be fully contained in the detent slot 170 and engagement ramp 168. This disengaged configuration allows the free movement of the fourth pole member 140 (shown in FIG. 3) into third pole member 138 (shown in FIG. 3) and allows a user to continue to push into subsequent portions of the pole spear assembly. Additional embodiments may include a coupling element 202. The coupling element 202 may include coupling detent slots 204 (shown in FIG. 19) which may align with the sidewall groves 172 and detent slots 170. Additionally, some embodiments may include an annular collar 212 and retention element 206 to further aid in the mechanical movement of detent elements 144 and the pole spear assembly 100 more generally. The retention element may further include retention detent slots 208. An (third) abutment element 213 is additionally shown and it should be clarified that the term “abutment element” may be used to refer to the first abutment element 210, the second abutment element 211, and the third abutment element 213.

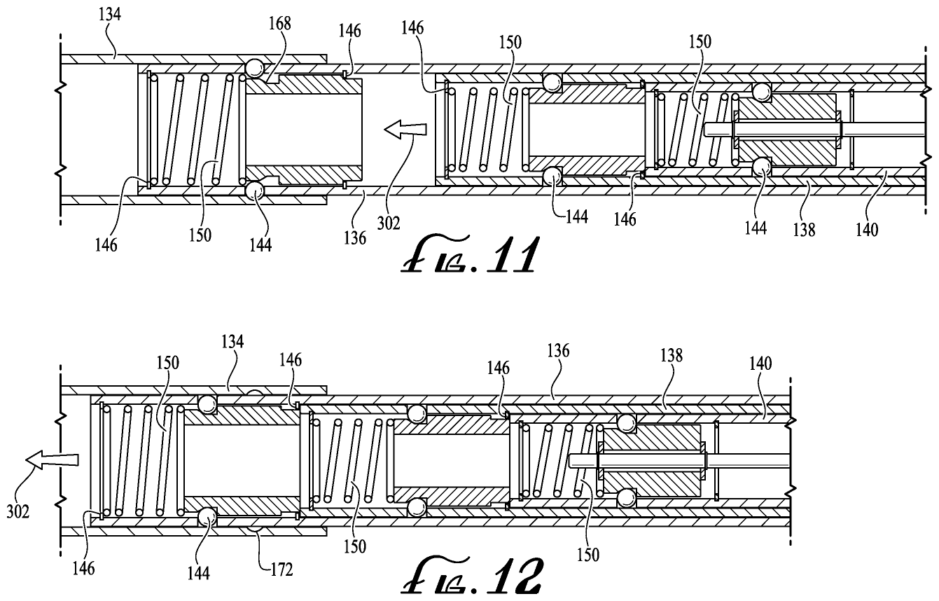

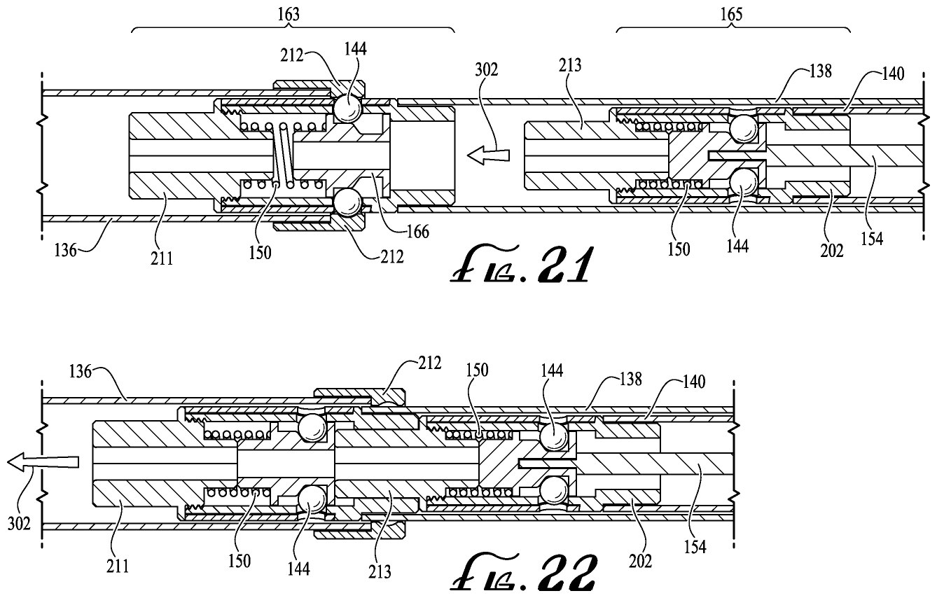

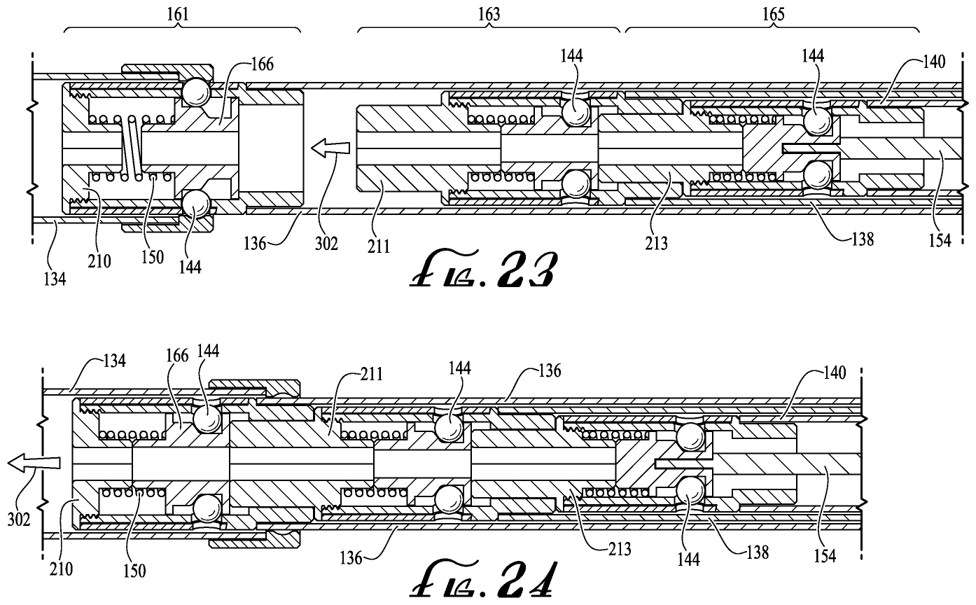

Referring to FIGS. 9 through 12, and 21 through 24, shown is the further collapse of the pole spear assembly 100. The initiation of the collapse of the fourth pole member 140 into third pole member 138 had been illustrated as being initiated and illustrated in FIGS. 6, 7, and 8. Accordingly, one advantageous feature of the present disclosure is the automatic nature of the collapse of the pole spear assembly. This may be illustrated in FIGS. 8, 9, 10, 11, and 12. As each preceding section collapses into an adjacent section, the mechanism of disengagement is repeated. The intersection assembly (as illustrated in FIGS. 3 and 27) may operate in a similar manner for each of the first intersection assembly 160, second intersection assembly 162, and third intersection assembly 164 (intersections as illustrated in FIG. 4). As previously described the biasing element 150 maintains a resilient bias against plunger element 148 which translates this bias to the detent element 144 via the engagement ramp 168 and maintains a locked configuration with the detent element 144 being inserted through the detent slot 170 and into the sidewall groove 172 for each of the first intersection 160, second intersection 162, and third intersection 164. This may be differentiated from FIGS. 6, 7, and 8 in which the release button 122 initiated the collapse. However, for each section thereafter, the collapse may be perpetuated by the contact of the preceding section against the plunger element 148, or other element, of the adjacent, or collapsing section. This may be illustrated by a comparison of FIG. 9 with FIG. 10, a comparison of FIG. 11 with FIG. 12, a comparison with FIG. 21 with FIG. 22, and a comparison with FIG. 23 with FIG. 24.

Additional embodiments may include a coupling element 202. The coupling element 202 may include coupling detent slots 204 (shown in FIG. 19) which may align with the sidewall groves 172 and detent slots 170. Additionally, some embodiments may include an annular collar 212 and retention element 206 to further aid in the mechanical movement of detent elements 144 and the pole spear assembly 100 more generally. The retention element may further include retention detent slots 208. A (second) abutment element 211 is additionally shown and it should be clarified that the term “abutment element” may be used to refer to the first abutment element 210, the second abutment element 211, and the third abutment element 213.

As illustrated in FIGS. 9, 10, 21, and 22, the impending compressional force from the fourth pole member 140 into the plunger element 148 of the third pole member 138 shifts the position of plunger element 148. This force results in compression of biasing element 150 of the third pole member and release of detent element 144 from the engagement groove 166 for the third pole member 138 as illustrated in FIG. 10. This allows the third pole member 138 to slide into the second pole member 136. Additional embodiments may include a coupling element 202. The coupling element 202 may include coupling detent slots 204 (shown in FIG. 19) which may align with the sidewall groves 172 and detent slots 170. Additionally, some embodiments may include an annular collar 212 and retention element 206 to further aid in the mechanical movement of detent elements 144 and the pole spear assembly 100 more generally. The retention element may further include retention detent slots 208. A (second) abutment element 211 is additionally shown and it should be clarified that the term “abutment element” may be used to refer to the first abutment element 210, the second abutment element 211, and the third abutment element 213.

As illustrated in FIGS. 11, 12, 23, and 24, the impending compressional force from the third pole member 138 into the plunger element 148 of the second pole member 136 shifts the position of the plunger element 148. This force results in compression of biasing element 150 of the second pole member and release of detent element 144 from the engagement groove 166 for the second pole member 138 as illustrated in FIG. 10. This allows the second pole member 136 to slide into the first pole member 134. Additional embodiments may include a coupling element 202. The coupling element 202 may include coupling detent slots 204 (shown in FIG. 19) which may align with the sidewall groves 172 and detent slots 170. Additionally, some embodiments may include an annular collar 212 and retention element 206 to further aid in the mechanical movement of detent elements 144 and the pole spear assembly 100 more generally. The retention element may further include retention detent slots 208. A (first) abutment element 210 is additionally shown and it should be clarified that the term “abutment element” may be used to refer to the first abutment element 210, the second abutment element 211, and the third abutment element 213.

Shown in FIGS. 13, 14, 25 and 26, is the pole spear assembly 100 in a collapsed configuration. Those skilled in the art may appreciate the compact nature of the fishing apparatus, as such a configuration as indicated in FIG. 13 may facilitate easy transport and storage. FIG. 14 shows each of the fourth pole member 140, third pole member 138, second pole member 136 nested internal to each other, and all mentioned members nested internal to the first pole member 134. Thus, the first pole member 134 may have a larger diameter than all other sections, as all sections nest internal to said first pole member 134 sequentially.

Having disclosed the structure of the preferred embodiments, it is now possible to describe its function, operation, and use. The pole spear assembly 100 may be constructed of generally corrosive resistant materials as the primary intended in situ locations for use will be aquatic. Use in both freshwater and saltwater is contemplated. The first pole member 134, second pole member 136, third pole member 138, and fourth pole member 140 may be constructed of carbon fiber materials known in the industry, or of other similarly rigid materials, such as basal fabric, fiberglass, hemp weave, plastics, aluminum, or the like. Moreover, for such materials like carbon fiber, it is contemplated that the fiber will be impregnated with resins commonly used in the industry to provide structural rigidity through the creation of composite materials. Any such fabric type material may be used in combination with a resin, for example, fiberglass or basal fabrics, and other similar type fabric material. The resins contemplated are commonly used in the industry, for example, epoxy or polyester or other similar component type resins. The resins may harden through stoichiometric reactions, via catalytic reactions, or via other commonly known reaction mechanisms.

Parts that are constructed from metals are contemplated to be constructed from corrosion-resistant metals, preferably steel which is low in carbon and high in nickel, for example, stainless steel. Further, other corrosion-resistant metals are contemplated such as aluminum, titanium, copper, bronze, brass, or galvanized steel. Parts throughout this disclosure may be made of metals as described in this paragraph or maybe milled and/or machined from carbon fiber impregnated with resins of any variety. Moreover, parts throughout this disclosure may be made of fiberglass, where appropriate and suitable for the specific application.

Further, having such a compact size when collapsed means that the pole spear assembly 100 is easy to store, transport, and generally travel with. The pole spear assembly 100 may be placed into a holster or other type of transportation device, and may be taken to the in situ location for use in the collapsed, and holstered configuration.

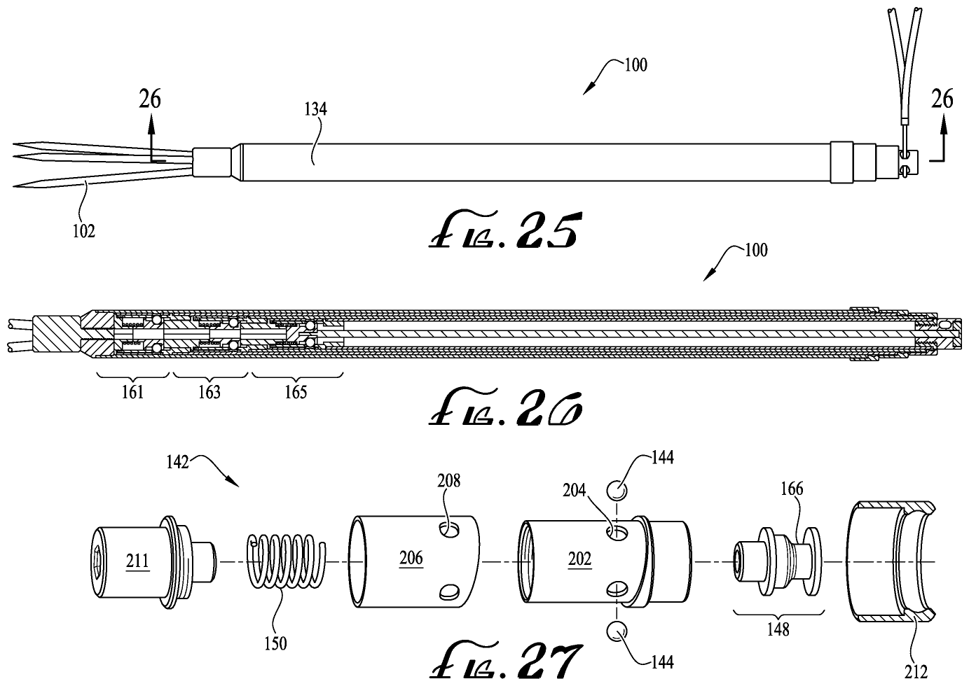

Further disclosed herein may be a collapsible and extendable rod 100 (also referred to as pole spear assembly 100) which may comprise a plurality of rod sections 500, each of the rod sections 500 being coupled together at any intersection of two said rod sections with an intersection assembly 142. Any two adjacent rod sections 500 may be configured such at least one of the two rod section 500 of the two adjacent rod sections 500 may nest internal to the other adjacent rod sections 500 thereby forming a collapsed configuration as seen in FIG. 25. The collapsed configuration may include any number of rod sections 500 provided there is at least a first largest rod section 134 and at least a last smallest rod section 140. The last smallest rod section 140 may be the most internal rod of the nested configuration and the first largest rod section 134 may be the most external of the nested configuration. The collapsed configuration may be fully reversible to an extended configuration. Further, the intersection assembly 142 may further comprise a plunge element 148 having a disengagement groove 166 disposed circumferentially about the plunge element 148, a coupling element 202 which may have a multiplicity of a coupling detent slots 204 and may be configured to couple any uncoupled rod sections together, a retention element 206 which may have a multiplicity of a retention detent slots 208, a multiplicity of detent elements 144 which may be configured to move between the disengagement groove 166 and both coupling detent slots 204 and the retention detent slots 208.

The said movement of the detent elements 144 from the coupling detent slots 204 and the retention detent slots 208 to the disengagement groove 166 may result in the collapsed configuration of the last rod section 140 into any of the adjacent rod section 500 until fully collapsed into the first rod section 134. Further, the movement of the detent elements 144 from the disengagement groove 166 to the coupling detent slots 204 and the retention detent slots 208 may result in a maintenance of the extended configuration of the any of the adjacent rod section out from the first rod section 134 until fully extended to the last rod section 140. A biasing element 150 may be configured to reversibly retain the detent elements 144 in the coupling detent slots 204 and the retention detent slots 208 when the spear is in an extended configuration. The intersection assembly 142 may further comprise an abutment element 210.

Additionally, the collapsible and extendable rod sections 500 may include at least a forward portion 108, a first middle portion 110, a second middle portion 112, and a rear portion 114. The rear portion 114 may further comprise a push rod 154, a release button 122, and a band loop 124. The push rod 154 may be disposed internal of the rear portion 114 and extending between the release button 122 and the plunge element 148 and configured to insertably engage with the plunge element 148 of the third intersection assembly 165.

The collapsibility of the pole spear may be initiated by a depression of the release button 122. This action may therein cause the push rod 154 to push the plunge element 48 of the third intersection assembly 165 and against the biasing element of the third intersection assembly 165. Said action may thereby cause the detent elements 144 to move from both the coupling detent slots 204 and the retention detent slots 208 into the disengagement groove 166 which thereby may allow the rear portion 114 to reversibly collapse into the second middle portion 112.

The collapse of the rear portion 114 into the second middle portion 112 may then cause the abutment element 210 of the third intersection assembly 165 to impact the plunge element 148 of the second intersection assembly 163. Such impact may thereby push the plunge element 148 of the second intersection assembly 163 to push against the biasing element 150 of the second intersection assembly 163. Such action may thereby cause the detent elements 144 to move from both the coupling detent slots 204 and the retention detent slots 208 into the disengagement groove 166. This may thereby allow the second middle portion 112 to collapse into the first middle portion 110.

The collapse of the second middle portion 112 into the first middle portion 110 may cause the abutment element 210 of the second intersection assembly 163 to impact the plunge element 148 of the first intersection assembly 161. Such impact may thereby push the plunge element 148 of the first intersection assembly 161 to push against the biasing element 150 of the first intersection assembly 161. Such push may thereby cause the detent elements 144 to move from both the coupling detent slots 204 and the retention detent slots 208 into the disengagement groove 166 thereby allowing the first middle portion 110 to collapse into the forward portion 108.

The band loop 124 may be configured to hold an elastic band, said elastic band being made of rubber. The first largest rod section may be further configured to threadably receive a tip insert 152, the tip insert may be configured to reversibly threadably receive a tip 102.

Further embodiments may include a telescoping pole spear assembly which may comprise a forward portion 108 being tubular and having an internal side 300, an external side 302, and being open at both ends. Additionally included may be a first middle portion 110 being tubular and having an internal side 300, an external side 302, and being open at both ends. Additionally included may be a second middle portion 112 being tubular and having an internal side 300, an external side 302, and being open at both ends. Additionally included may be a rear portion 114 being tubular and having an internal side 300, an external side 302, and being open at both ends.

The above noted forward portion 108 may be joined to the first middle portion 110 with a first intersection assembly 161. The first middle portion 110 may be joined to the second middle portion 112 with a second intersection assembly 163. The second middle portion 112 may be joined with the rear portion 114 with a third intersection assembly 165.

Accordingly, a collapsed configuration of the telescoping spear may be achieved by the rear portion 114 being configured to reversibly nest internal of the second middle portion 112. The second middle portion 112 may additionally be configured to reversibly nest internal of the first middle portion 110, and the first middle portion 110 may additionally be configured to reversibly nest internal of the forward portion. Further, an extended configuration of the telescoping spear may be achieved by the rear portion 114 being configured to reversibly extend from the internal side of the second middle portion 112, the second middle portion 112 being configured to reversibly extend from the internal side of the first middle portion 110, and the first middle portion 110 being configured to reversibly extend from the internal side of the forward portion 108.

The forward portion may further have a first pole member 134 and a tip insert 152, the tip insert may be configured to reversibly threadably receive a tip 102. The first middle portion 110 may further comprise a second pole member 136. The second middle portion 112 may further comprise a third pole member 138. The rear portion 114 may further comprise a first pole member 134.

Further, each of the first intersection assembly 161, the second intersection assembly 163, and the third intersection assembly 165 may further comprise a plunge element 148 having a disengagement groove 166 disposed circumferentially about the plunge element 148. Each may further comprise a coupling element 202 having a multiplicity of a coupling detent slots 204 and may be configured to couple the forward portion 108 with the first middle portion 110, the first middle portion 110 with the second middle portion 112, and the second middle portion 112 with the rear portion 114. Each may also further comprise a retention element 206 having a multiplicity of a spacing detent slots 208. Each may further comprise a multiplicity of detent elements 144 which may be configured to move between the disengagement groove 166 and both the multiplicity of coupling detent slots 204 and the multiplicity of retention detent slots 208.

Accordingly, the above the said movement of the detent elements 144 from the coupling detent slots 204 and the retention detent slots 208 to the disengagement groove 166 may result in the said collapsed configuration of the rear portion 114 into the second middle portion 112, the second middle portion 112 into the first middle portion 110, and the first middle portion 110 into the forward portion 108. Additionally, the above said movement of the detent elements 144 from the disengagement groove 166 to the coupling detent slots 204 and the retention detent slots 208 may result in a maintenance of the said extended configuration of the rear portion 114 out from the second middle portion 112, the second middle portion 112 out from the first middle portion 110, and the first middle portion 110 out from the forward portion 108.

Continuing, each of the above noted first intersection assembly 161, the second intersection assembly 163, and the third intersection assembly 165 may further comprise a biasing element 150 configured to reversibly retain the detent elements 144 in the coupling detent slots 204 and the retention detent slots 208 when the spear is in an extended configuration and an annular collar 212 configured to retain the coupling element with any of the forward portion 108, the first middle portion 110, and the second middle portion 112. Each may also further comprise an abutment element 210.

The telescoping pole spear assembly may further have a push rod 154, a release button 122, and a band loop 124 located to the rear portion 114. The push rod 154 may be disposed internal of the rear portion 114 and may extend between the release button 122 and the plunge element 148 and may be configured to insertably engage with the plunge element 148 of the third intersection assembly 165. As such, the collapsibility of the pole spear may be initiated by a depression of the release button 122 which may cause the push rod 154 to push the plunge element 48 of the third intersection assembly 165 and into the biasing element of the third intersection assembly 165 thereby causing the detent elements 144 to move from both the coupling detent slots 204 and the retention detent slots 208 into the disengagement groove 166 thereby allowing the rear portion 114 to reversibly collapse into the second middle portion 112.

This process may be automatic wherein the said collapse of the rear portion 114 into the second middle portion 112 may cause the abutment element 210 of the third intersection assembly 165 to impact the plunge element 148 of the second intersection assembly 163 which may thereby push the plunge element 148 of the second intersection assembly 163 against the biasing element 150 of the second intersection assembly 163 thereby causing the detent elements 144 to move from both the coupling detent slots 204 and the retention detent slots 208 into the disengagement groove 166 thereby allowing the second middle portion 112 to collapse into the first middle portion 110.

This process may be further automatic wherein the said collapse of the second middle portion 112 into the first middle portion 110 may cause the abutment element 210 of the second intersection assembly 163 to impact the plunge element 148 of the first intersection assembly 161 thereby pushing the plunge element 148 of the first intersection assembly 161 against the biasing element 150 of the first intersection assembly 161 thereby causing the detent elements 144 to move from both the coupling detent slots 204 and the retention detent slots 208 into the disengagement groove 166 thereby allowing the first middle portion 110 to collapse into the forward portion 108.

While various embodiments throughout this disclosure have been illustrated and described, it is not intended that these embodiments illustrate and describe all possible forms of the concept disclosed here. Rather, the words used in the specification are words of description rather than limitation, and it is understood that various changes may be made without departing from the spirit and scope of these various embodiments.

Accordingly, it is not intended that this disclosure be limited except by the appended claims. Insofar as the description above and the accompanying drawings disclose any additional subject matter that is not within the scope of the claims below, the various embodiments are not dedicated to the public and the right to file one or more applications to claim such additional embodiments is reserved.

What is claimed is:

1. A collapsible and extendable rod comprising:
a plurality of rod sections, each of the rod sections being coupled together at any an intersection of two said rod sections with an intersection assembly;
wherein any two adjacent rod sections are configured such that at least one of the two rod section, of the two adjacent rod sections, nests internal to the other rod section of the two adjacent sections, of the plurality of rod sections, thereby forming a collapsed configuration, said collapsed configuration includes any number of rod sections provided there is at least a first largest rod section and at least a last smallest rod section, the last smallest rod section being the most internal rod of the nested configuration and the first largest rod section being the most external of the nested configuration, and,
said collapsed configuration being fully reversible to an extended configuration.

2. The collapsible and extendable rod of claim 1, wherein the intersection assembly further comprises:
(a) a plunge element having a disengagement groove disposed circumferentially about the plunge element;
(b) a coupling element having a multiplicity of a coupling detent slots and configured to couple any uncoupled rod sections together;
(c) a retention element having a multiplicity of a retention detent slots;
(d) a multiplicity of detent elements configured to move between the disengagement groove and both coupling detent slots and the retention detent slots, wherein:
(i) the said movement of the detent elements from the coupling detent slots and the retention detent slots to the disengagement groove resulting in the said collapsed configuration of the last rod section into any of the adjacent rod section until fully collapsed into the first rod section; and
(ii) the said movement of the detent elements from the disengagement groove to the coupling detent slots and the retention detent slots resulting in a maintenance of the said extended configuration of the any of the adjacent rod section out from the first rod section until fully extended to the last rod section;
(e) a biasing element configured to reversibly retain the detent elements in the coupling detent slots and the retention detent slots when the spear is in an extended configuration; and,
(f) an abutment element.

3. The collapsible and extendable rod of claim 1, wherein the rod sections include at least a forward portion, a first middle portion, a second middle portion, and a rear portion.

4. The collapsible and extendable rod of claim 3, wherein the rear portion further comprises a push rod, a release button, and a band loop.

5. The collapsible and extendable rod of claim 4, wherein the push rod is disposed internal of the rear portion and extending between the release button and the plunge element and configured to insertably engage with the plunge element of the third intersection assembly, wherein:
(a) the collapsibility of the pole spear being initiated by a depression of the release button causing the push rod to push the plunge element of the third intersection assembly against the biasing element of the third intersection assembly thereby causing the detent elements to move from both the coupling detent slots and the retention detent slots into the disengagement groove thereby allowing the rear portion to reversibly collapse into the second middle portion;
(b) the said collapse of the rear portion into the second middle portion causing the abutment element of the third intersection assembly to impact the plunge element of the second intersection assembly thereby pushing the plunge element of the second intersection assembly to push against the biasing element of the second intersection assembly thereby causing the detent elements to move from both the coupling detent slots and the retention detent slots into the disengagement groove thereby allowing the second middle portion to collapse into the first middle portion; and,
(c) the said collapse of the second middle portion into the first middle portion causing the abutment element of the second intersection assembly to impact the plunge element of the first intersection assembly thereby pushing the plunge element of the first intersection assembly to push against the biasing element of the first intersection assembly thereby causing the detent elements to move from both the coupling detent slots and the retention detent slots into the disengagement groove thereby allowing the first middle portion to collapse into the forward portion.

6. The collapsible and extendable rod of claim 7, wherein the band loop is configured to hold an elastic band, said elastic band being made of rubber.

7. The collapsible and extendable rod of claim 1, wherein the first largest rod section is further configured to threadably receive a tip insert, the tip insert configured to reversibly threadably receive a tip.

8. A telescoping pole spear assembly comprising:
a forward portion being tubular and having an internal side, an external side, and being open at both ends;
a first middle portion being tubular and having an internal side, an external side, and being open at both ends;
a second middle portion being tubular and having an internal side, an external side, and being open at both ends;
a rear portion being tubular and having an internal side, an external side, and being open at both ends; and
the forward portion being joined to the first middle portion with a first intersection assembly, the first middle portion being joined to the second middle portion with a second intersection assembly, and the second middle portion being joined with the rear portion with a third intersection assembly;
wherein a collapsed configuration of a telescoping spear is achieved by the rear portion being configured to reversibly nest internal of the second middle portion, the second middle portion being configured to reversibly nest internal of the first middle portion, and the first middle portion being configured to reversibly nest internal of the forward portion; and
wherein an extended configuration of the telescoping spear is achieved by the rear portion being configured to reversibly extend from the internal side of the second middle portion, the second middle portion being configured to reversibly extend from the internal side of the first middle portion, and the first middle portion being configured to reversibly extend from the internal side of the forward portion.

9. The telescoping pole spear assembly of claim 8, wherein the forward portion further having a first pole member and a tip insert, the tip insert configured to reversibly threadably receive a tip.

10. The telescoping pole spear assembly of claim 8, wherein the first middle portion further comprises a second pole member.

11. The telescoping pole spear assembly of claim 8, wherein the second middle portion further comprises a third pole member.

12. The telescoping pole spear assembly of claim 8, wherein the rear portion further comprises a fourth pole member.

13. The telescoping pole spear assembly of claim 8, wherein the first intersection assembly, the second intersection assembly, and the third intersection assembly each further comprising;
(a) a plunge element having a disengagement groove disposed circumferentially about the plunge element;
(b) a coupling element having a multiplicity of a coupling detent slots and configured to couple:
(i) the forward portion with the first middle portion,
(ii) the first middle portion with the second middle portion, and
(iii) the second middle portion with the rear portion;
(c) a retention element having a multiplicity of a spacing detent slots;
(d) a multiplicity of detent elements configured to move between the disengagement groove and both the multiplicity of coupling detent slots and the multiplicity of retention detent slots, wherein:
(i) the said movement of the detent elements from the coupling detent slots and the retention detent slots to the disengagement groove resulting in the said collapsed configuration of the rear portion into the second middle portion, the second middle portion into the first middle portion, and the first middle portion into the forward portion; and
(ii) the said movement of the detent elements from the disengagement groove to the coupling detent slots and the retention detent slots resulting in a maintenance of the said extended configuration of the rear portion out from the second middle portion, the second middle portion out from the first middle portion, and the first middle portion out from the forward portion;
(e) a biasing element configured to reversibly retain the detent elements in the coupling detent slots and the retention detent slots when the spear is in an extended configuration;
(f) an annular collar configured to retain the coupling element with any of the forward portion, the first middle portion, and the second middle portion; and,
(g) an abutment element.

14. The telescoping pole spear assembly of claim 8, wherein the rear portion further comprises a push rod, a release button, and a band loop.

15. The telescoping pole spear assembly of claim 14, wherein the push rod is disposed internal of the rear portion and extending between the release button and the plunge element and configured to insertably engage with the plunge element of the third intersection assembly, wherein:
(a) the collapsibility of the pole spear being initiated by a depression of the release button causing the push rod to push the plunge element of the third intersection assembly against the biasing element of the third intersection assembly thereby causing the detent elements to move from both the coupling detent slots and the retention detent slots into the disengagement groove thereby allowing the rear portion to reversibly collapse into the second middle portion;
(b) the said collapse of the rear portion into the second middle portion causing the abutment element of the third intersection assembly to impact the plunge element of the second intersection assembly thereby pushing the plunge element of the second intersection assembly against the biasing element of the second intersection assembly thereby causing the detent elements to move from both the coupling detent slots and the retention detent slots into the disengagement groove thereby allowing the second middle portion to collapse into the first middle portion; and,
(c) the said collapse of the second middle portion into the first middle portion causing the abutment element of the second intersection assembly to impact the plunge element of the first intersection assembly thereby pushing the plunge element of the first intersection assembly against the biasing element of the first intersection assembly thereby causing the detent elements to move from both the coupling detent slots and the retention detent slots into the disengagement groove thereby allowing the first middle portion to collapse into the forward portion.

16. The telescoping pole spear assembly of claim 14, wherein the band loop is configured to hold an elastic band, said elastic band being made of rubber.

17. The telescoping pole spear assembly of claim 9, wherein the plurality of rods are made of carbon fiber impregnated with a thermoplastic resin.

18. A collapsible pole spear assembly comprising:
a forward portion being tubular and having an internal side, an external side, and being open at both ends, the forward portion further having a first pole member and a tip insert, the tip insert configured to reversibly threadably receive a tip;
a first middle portion being tubular and having an internal side, an external side, and being open at both ends, the first middle portion further having a second pole member;
a second middle portion being tubular and having an internal side, an external side, and being open at both ends, the second middle portion further having a third pole member;
a rear portion being tubular and having an internal side, an external side, and being open at both ends, the rear portion further having a fourth pole member, a push rod, a release button, and a band loop; and,
the forward portion being joined to the first middle portion with a first intersection assembly, the first middle portion being joined to the second middle portion with a second intersection assembly, and the second middle portion being joined with the rear portion with a third intersection assembly.

19. The collapsible pole spear assembly of claim 18, wherein the first intersection assembly, the second intersection assembly, and the third intersection assembly each further comprises;
(a) a plunge element having a disengagement groove disposed circumferentially about the plunge element;
(b) a coupling element having a multiplicity of a coupling detent slots and configured to couple:
(i) the forward portion with the first middle portion,
(ii) the first middle portion with the second middle portion, and
(iii) the second middle portion with the rear portion;
(c) a retention element having a multiplicity of a spacing detent slots;
(d) a multiplicity of detent elements configured to move between the disengagement groove and both the multiplicity of coupling detent slots and the multiplicity of retention detent slots, wherein:
(i) the said movement of the detent elements from the coupling detent slots and the retention detent slots to the disengagement groove resulting in a collapsibility of the rear portion into the second middle portion, the second middle portion into the first middle portion, and the first middle portion into the forward portion; and,
(ii) the said movement of the detent elements from the disengagement groove to the coupling detent slots and the retention detent slots resulting in the extendibility of the rear portion into the second middle portion, the second middle portion into the first middle portion, and the first middle portion into the forward portion;
(e) a biasing element configured to reversibly retain the detent elements in the coupling detent slots and the retention detent slots when the spear is in an extended configuration;
(f) an annular collar configured to retain the coupling element with any of the forward portion, the first middle portion, and the second middle portion; and,
(g) an abutment element.

20. The collapsible pole spear assembly of claim 18, wherein the rear portion further has a push rod and a release button, the push rod being disposed internal of the rear portion and extending between the release button and the plunge element and configured to insertably engage with the plunge element of the third intersection assembly, wherein:
(a) the collapsibility of the pole spear being initiated by a depression of the release button causing the push rod to push the plunge element of the third intersection assembly against the biasing element of the third intersection assembly thereby causing the detent elements to move from both the coupling detent slots and the retention detent slots into the disengagement groove thereby allowing the rear portion to reversibly collapse into the second middle portion;
(b) the said collapse of the rear portion into the second middle portion causing the abutment element of the third intersection assembly to impact the plunge element of the second intersection assembly thereby pushing the plunge element of the second intersection assembly to push against the biasing element of the second intersection assembly thereby causing the detent elements to move from both the coupling detent slots and the retention detent slots into the disengagement groove thereby allowing the second middle portion to collapse into the first middle portion; and,
(c) the said collapse of the second middle portion into the first middle portion causing the abutment element of the second intersection assembly to impact the plunge element of the first intersection assembly thereby pushing the plunge element of the first intersection assembly to push against the biasing element of the first intersection assembly thereby causing the detent elements to move from both the coupling detent slots and the retention detent slots into the disengagement groove thereby allowing the first middle portion to collapse into the forward portion.
